(19) United States
(12) Patent Application Publication
(10) Pub. No.: US 2002/0131080 A1
(43) Pub. Date: Sep. 19, 2002

(54) Print system

(76) Inventor: Jun Enomoto, Kanagawa (JP)

Correspondence Address: BIRCH STEWART KOLASCH & BIRCH, PO BOX 747, FALLS CHURCH, VA, 22040-0747, US

(21) Appl. No.: 10/099,993

(22) Filed: Mar. 19, 2002

(30) Foreign Application Priority Data
Mar. 19, 2001 (JP) 2001-078838
Mar. 21, 2001 (JP) 2001-080079

(51) Int. Cl. B41F 1/00; G06F 15/00

(52) U.S. Cl. 358/1.15

(57) ABSTRACT

The print system includes a storage device which stores an image processing condition of an image used in care of simultaneously printing and image retrieval data for retrieving the image processing condition or compressed image data the processed image data, as image reproducing information and a retrieval device which performs a retrieval operation using the image retrieval data in accordance with an image reorder printing request and reads the image processing condition from the storage device. An image designated request for reorder printing is read photoelectrically from the photographic film, and the image processing is performed on the read image according to the image processing condition retrieved by the retrieval device so that the image is output as an output image. The print system can effectively output a print matching the image of the previous print in color and density in case of the request for reorder printing such as extra printing.

### BACKGROUND OF THE INVENTION

1. Field of the Invention

The present invention belongs to a technical field of a print system for outputting a print (photograph) reproducing an image photographed on a film or an image photographed by a digital camera, and in particular, relates to a print system, which can preferably make an image identity of a simultaneous print with a reprint in such a print system.

2. Related Background Art

Conventionally, in order to print an image photographed on photographic films (hereinafter, referred simply to as “film”) such as a negative film and a reversal film to a photosensitive material (photographic paper), a so-called direct exposure has been mainly employed such that an image on the film is projected to the photosensitive material and exposed.

On the contrary, in recent years, a printer (printing device) using digital exposure, that is, a digital photo printer (photographic printer) has been practically used. More specifically, the digital photo printer photoelectrically reads an image recorded on a film, and converts the read image into a digital signal, and thereafter, performs various image processings to the image so as to obtain a recording image data. Further, the digital photo printer scans and exposes a photosensitive material by a recording light modulated in accordance with the image data thus obtained so as to record an image (latent image), and thereafter, outputs the image as a (finished) print.

The digital photo printer is composed of a scanner (image reader), an image processor, a printer (image recorder), and a processor (developing device), in general. More specifically, the scanner makes a reading light incident upon a film so as to read a projection light thereof, and thereby, photoelectrically reads an image recorded on the film. The image processor performs a predetermined processing to an image data read by the scanner or an image data supplied from a digital camera, etc., to obtain an image data for recording the image, that is, an exposure condition. The printer scans and exposes the photosensitive material by, for example, light beam scan in accordance with the image data output by the image processor, and records a latent image. The processor develops the photosensitive material exposed by the printer so as to obtain a (finished) print in which the image is reproduced.

The above digital photo printer can adjust the image as digital image data by image data processing; therefore, the digital photo printer preferably performs correction on washed-out and flat image resulting from back light and strobe flash, sharpness processing and the like. As a result, it is possible to obtain a high-quality print, which has not been obtained by the conventional direct exposure.

In addition, the digital photo printer can output an image photographed by a digital camera, etc., as a print.

By the way, in the print output by using the image photographed on the film and the image data photographed by the digital camera as well as the above digital photo printer, the following case frequently occurs; in accordance with a request of extra printing, a so-called reorder printing (hereinafter, referred to as “reprinting”) is performed such that the image (frame) once printed is again output as a print.

In such a case, in particular, in the case where there is no correction request, the identity (matching) of image reproduced in the print is required between the previously output print (usually, the simultaneous print reproducing and outputting the image photographed on the photographic film) and reprint. However, there are many cases where the color and density of image are different between the previous print and the reprint due to, for example, different judgment and operation by an operator; for this reason, there is a problem such that a complaint from customers is frequently made.

On the contrary, in order to simplify a method of reordering photographic print, the present applicant has already proposed a photographic print system in JP 09-179211 A and JP 09-055834 A. In the photographic print system, an image photographed on a film is stored in a storage medium together with information specifying the image, and then, in reprinting, the image is reproduced by merely specifying the information corresponding to the image to be reproduced. By doing so, reorder is possible without handling the film.

Further, the present applicant has proposed an image processor in JP 2000-222437 A, which can simply retrieve image data and image processing information from a database storing image data and image processing information thereof in reprinting, and can effectively output a reprint having an image identical (identical) with the previous print.

### SUMMARY OF THE INVENTION

The present invention has an objective to solve the above mentioned problems with the conventional arts and to improve the arts disclosed by the above publications by providing a print system that outputs a print reproducing an image photographed on a photographic film or photographed by a digital camera and the like, wherein a reprint with an image being identical in color and density with the previously output print can be effectively output.

The applicant has proposed an image processor in Japanese Patent Application No. 11-156757 and No. 2000-118063 specifications, which can simply retrieve an image data and an image processing information from a database storing the image and its image processing information, and can effectively output a reprint having an image identical with the previous print; the present invention is to further improve the suggested arts.

In order to attain the object described above, the first aspect of the present invention provides a print system, comprising: an image input device which photoelectrically reads an image photographed on a photographic film so as to input the read image as image data of an input image; an image processing device which performs image processing on the input image; an image output device which outputs the processed image as an output image reproducing the image photographed on the photographic film to a predetermined recording medium; a storage device which stores an image processing condition relative to each image when generating the output image reproducing the photographed image and image retrieval data for retrieving the image processing condition or compressed image data obtained by compressing the image data, as image reproducing information when generating the output image reproducing the photographed image; and a retrieval device which performs a retrieval operation on the storage device using the image retrieval data in accordance with an image reorder printing request and reads the image processing condition from the storage device, wherein, when the image reorder printing request is made, an image designated for reorder printing is read photoelectrically from the photographic film, and the image processing is performed on the read image according to the image processing condition when generating the output image reproducing the photographed image retrieved by the retrieval device so that the image is output as an output image.

Preferably, the image retrieval data is image characteristics data fetched when generating the compressed image data.

Preferably, a selection can be made as to whether or not the compressed image data is stored in the storage device.

Preferably, the image retrieval data, the image processing condition and the compressed image data are individually related to each other, and when any one of these data is deleted, the rest of these data is deleted, or when any one of these data is updated, the rest of these data is updated.

Preferably, the image retrieval data, the image processing condition and the compressed image data are individually related to each other and managed on a database of the storage device every at least one or more of frame number, kind of film, type of camera, customer, particular ID of image, order received year/month/day, order received shop, printer, order, film format, type of film carrier, film mask, year/month/day/time of when photographed, image format and order terminal.

Preferably, the print system is further connected to the other print systems via a network, and the other print systems connected to the network are also retrieved when performing the retrieval operation using the image retrieval data upon handling the reorder of the image.

Preferably, the image reproducing information is managed by a server of the network, and the server is also retrieved when performing the retrieval operation.

Preferably, a retrieval range and a retrieval condition can be preset when performing the retrieval operation.

Preferably, the image reproducing information, the image retrieval data and the compressed image data are backed up at predetermined timing.

Preferably, the predetermined timing is any one of system startup, startup inspection, inspection on work finishing, system shutdown, system hang-up, time when instruction is given by an operator and software version up.

Preferably, the number of frames of storable image reproducing information is set in accordance with print system performance and resource, and further, is changeable.

Preferably, the image processing condition and the image characteristics data related thereto are independently stored as the image reproducing information, or a set of the image processing condition and the image characteristics data related thereto is stored as the image reproducing information.

Preferably, the image reproducing information is obtained by loading image reproducing information of a predetermined print system or referring thereto at predetermined timing.

Preferably, the loaded image reproducing information can be deleted after an image reorder handling is completed.

In order to attain the object described above, the second aspect of the present invention provides a print system comprising: an image input device which photoelectrically reads an image photographed on a photographic film so as to input the read image as image data of an input image; an image processing device which performs image processing on the input image; an image output device which outputs the processed image as an output image reproducing the image photographed on the photographic film to a predetermined recording medium; a storage device which stores an image data after being processed by the image processing device and before being converted into an output format corresponding to the predetermined recording medium, as an image reproducing information when generating the output image reproducing the photographed image, together with an image identification code for specifying the image data; and a retrieval device which performs a retrieval operation on the storage device using the image identification code in accordance with an image reorder printing request and reads the image reproducing information from the storage device, wherein, when the image reorder printing request is made, the processed image data corresponding to the image designated for reorder printing is read from the storage device using the image identification code, and is output to the predetermined recording medium from the image output device.

Preferably, the processed image data stored as the image reproducing information is image data subjected to at least one image processing of electronic scaling processing, color gradation, color density correction processing, sharpness processing, and dodging processing.

Preferably, the processed image data stored as the image reproducing information is related to each other and managed on a database of the storage device every at least one or more of frame number, kind of film, type of camera, customer, particular ID of image, order received year/month/day, order received shop, printer, order, film format, type of film carrier, film mask, year/month/day/time of when photographed, image format and order terminal.

Preferably, the print system is further connected to the other print systems via a network, and the other print systems connected to the network are also retrieved when retrieving the image reproducing information upon handling the reorder of the image.

Preferably, the processed image data stored as the image reproducing information is managed by a server of the network, and the server is also retrieved when performing the retrieval operation.

Preferably, the image reproducing information, the image retrieval data and the processed image data stored as the compressed image data are backed up at predetermined timing.

Preferably, the predetermined timing is any one of system startup, startup inspection, inspection on work finishing, system shutdown, system hang-up, time when instruction is given by an operator and software version up.

Preferably, a retrieval range and a retrieval condition can be preset when performing the retrieval operation.

Preferably, the number of frames of storable image reproducing information is set in accordance with print system performance and resource, and further, is changeable.

Preferably, the image reproducing information is obtained by loading image reproducing information of a predetermined print system at predetermined timing.

Preferably, the loaded image reproducing information can be deleted after an image reorder handling is completed.

Preferably, a selection can be made as to whether the image after the reorder handling is output using the same print system as used when generating the output image reproducing the image photographed on the photographic film, or using another print system.

In order to attain the object described above, the third aspect of the present invention provides a print system comprising: an image input device which photoelectrically reads an image photographed on a photographic film so as to input the read image as image data of an input image; an image processing device which performs image processing on the input image; an image output device which outputs the processed image as an output image reproducing the image photographed on the photographic film to a predetermined recording medium; a storage device which stores an image data after being processed by the image processing device and before being converted into an output format corresponding to the predetermined recording medium, an image processing condition relative to each image when generating an output image reproducing the photographed image, an image retrieval data for specifying the image processing condition or the processed image data, or compressed image data obtained by compressing the image data, as an image reproducing information when generating the output image reproducing the photographed image; a retrieval device which retrieves the processed image data or the image processing condition from the storage device using the image retrieval data in accordance with an image reorder printing request; and a judgment device which judges whether or not there is a change between the image processing condition when the output image reproducing the photographed image is generated and that when the reorder is made, wherein, when there is no change in the image processing condition upon the reorder, the image is output using the processed image data stored in the storage device, and wherein, when there is a change in the image processing condition upon the reorder, the image is newly read from the photographic film, and the image processing condition corresponding to the image stored in the storage device is accessed and changed so that image processing is performed to the read image according to the changed image processing condition.

Preferably, even though there is a change in the image processing condition upon the reorder, when the change is within a preset allowable range, the image is output using the processed image data stored in the storage device.

Preferably, the storage device stores the image reproducing information only for a predetermined period, and stores the image retrieval data and the image processing condition or optionally the compressed image data of the image reproducing information after elapse of the predetermined period, and the processed image data is erased.

Preferably, the predetermined period can be preset by an operator.

It is preferable that the print system further comprises a display capable of displaying an image, wherein, retrieval result of the image reproducing information is displayed on the display upon the reorder.

Preferably, when a retrieval object is not found from the retrieval result, or when an error in retrieving is made, images listed as a second candidate and the following can be displayed, or instruction for retrieving can be given again.

It is also preferable that the print system further comprises a back-printing device which performs back-printing on a print of the output image, wherein the back-printing showing retrieval result of the image reproducing information is performed upon the reorder.

Preferably, when the storage device stores the image reproducing information, the number of frames of storable image reproducing information is set in accordance with print system performance and resource, and further, is changeable, or further optionally a selection can be made as to whether or not the compressed image data is stored.

Preferably, the image processing condition and the image characteristics data related thereto are independently stored as the image reproducing information, or a set of the image processing condition and the image characteristics data related thereto is stored as the image reproducing information.

### BRIEF DESCRIPTION OF THE DRAWINGS

The above and further objects and features of the present invention will become more fully apparent from the following detailed description with reference to the accompanying drawings in which:

FIG. 1 is a block diagram schematically showing a structure of digital photo printer of a print system in accordance with an embodiment of the present invention;

FIG. 2 is a block diagram schematically showing a structure of image processor in accordance with a first embodiment of the present invention;

FIG. 3 is a view schematically explaining a flow of the entire process for the case of a 135-size film when a film scan is performed in the first embodiment;

FIG. 4A is a flowchart showing a flow of the simultaneous printing process in the case of a 135-size film in the first embodiment, and FIG. 4B is a flowchart showing a flow of reprinting process in the same case as above;

FIG. 5 is a view schematically explaining a flow of the entire process for the case of an APS 240-size film in the first embodiment;

FIG. 6A is a flowchart showing a flow of the simultaneous printing process in the case of the 240-size film in the first embodiment, and FIG. 6B is a flowchart showing a flow of reprinting process in the same case as above;

FIG. 7A is a view explaining an example in which a plurality of print systems are interconnected via a network, and FIG. 7B is a view explaining a state that a plurality of print systems are connected with an image server so as to perform data centralized control;

FIG. 8 is a block diagram schematically showing a structure of image processor in accordance with a second embodiment of the present invention;

FIG. 9 is a block diagram schematically showing a structure of image processor in accordance with a third embodiment of the present invention;

FIG. 10 is a flowchart showing a flow of rough process in the case of a 135-size film in the third embodiment of the present invention; and

FIG. 11 is a flowchart showing a flow of rough process in the case of an APS film in the third embodiment.

### DETAILED DESCRIPTION OF THE PREFERRED EMBODIMENTS

The preferred embodiments of a print system according to the present invention will be described in detail with reference to the accompanying drawings.

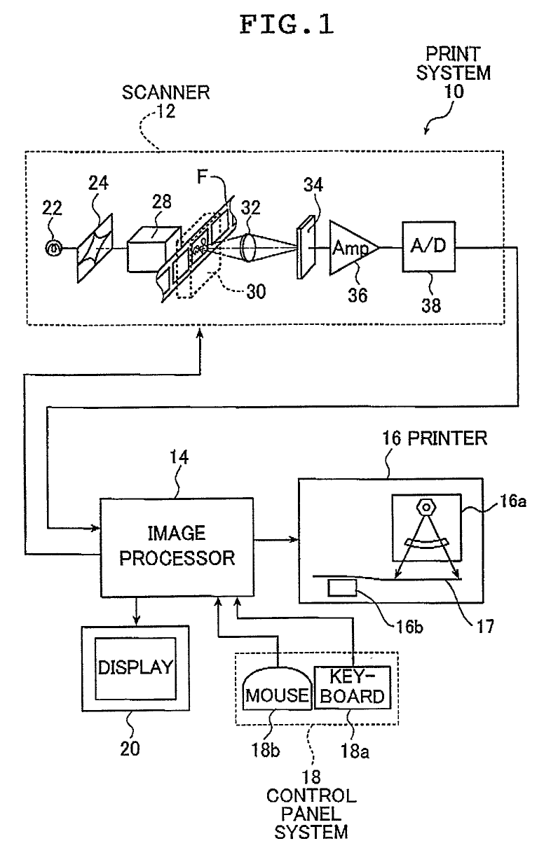

FIG. 1 is a block diagram schematically showing a structure of digital photo printer given as one embodiment of a print system according to the present invention.

Incidentally, the print system of the present invention is not limited to the above digital photo printer, and may be a conventional direct exposure type analog photo printer, which performs printing to photographic paper by using a projection light.

A print system 10 shown in FIG. 1 mainly comprises a scanner (image reader) 12, an image processor 14, which is the constituent feature of the present invention, and a printer 16. More specifically, the scanner 12 photoelectrically reads an image photographed on a film F. The image processor 14 stores image reproducing information, retrieves the image reproducing information in reprinting so as to obtain an image processing condition, and thereafter, performs processing of the read image data according to the obtained image processing condition so that an output image data can be obtained. Further, the image processor 14 performs the entire operation and control. of the print system 10. The printer 16 exposes and develops a photosensitive material (photographic paper) by a light beam modulated in accordance with the image data output by the image processor 14, and outputs it as a (finished) print.

Moreover, the above image processor 14 is connected with a control panel (input operating) system 18 having a keyboard 18a and a mouse 18b, and a display 20. More specifically, the control panel system 18 inputs various conditions to input and setup, processing selection and instructions, instructions of color/density correction and the like. The display 20 displays an image read by the scanner 12, various operating instructions, condition setup/registered screen, image retrieval results in reprinting, and the like.

The scanner 12 is equivalent to an image input device of the present invention, and is a device for photoelectrically reading the image photographed on the film F. Further, the scanner 12 comprises a light source 22, a variable diaphragm 24, a diffusion box 28, an imaging lens unit 32, an image sensor 34, an amplifier 36 and an A/D (analog/digital) converter 38. More specifically, the diffusion box 28 makes a reading light incident upon the film F uniform in the plane direction of the film F, and the image sensor 34 includes a line CCD sensor that corresponds to each image reading in R (red), G (green) and B (blue).

Moreover, the print system 10 is provided with a dedicated carrier 30, which is freely mountable to the main body of the scanner 12. The carrier 30 is used in accordance with a kind and a size of a film such as an Advanced Photo System (hereinafter, referred simply as to “APS”) and a 135-size negative (or reversal) film, and a film type such as a strip and a slide; by replacing the above carrier 30, the print system can perform corresponding to various film types and processings. An image (frame) photographed on the film F and output as a print is fed to a predetermined reading position by the carrier 30.

In the above scanner 12, when reading the image photographed on the film F, a reading light is emitted from the light source 22, and then, its light quantity is adjusted by the variable diaphragm 24. Then, the reading light is incident upon the film F positioned to the predetermined reading position by the carrier 30, and thereafter, is transmitted so as to obtain a projection light bearing the image photographed on the film F.

The carrier 30 includes a feed roller pair for feeding the film F to a predetermined reading position, and a mask having a slit for regulating the projection light of the film F to a predetermined slit shape in the same direction (main scanning direction) as the line CCD sensor. The film F is positioned to the reading position by the carrier 30, and thereafter, the reading light is incident upon the film F while the film F is being fed in a state such that the longitudinal direction of the film F coincides with a sub-scanning direction orthogonal to the main scanning direction. As a result, by doing so, the film F is two-dimensionally slit-scanned by a slit extending in the main scanning direction, and an image of each frame photographed on the film F is read.

The APS film is formed with a magnetic recording medium, and the carrier 30 corresponding to the APS film (cartridge) is provided with a magnetic head, which records and reads information in the magnetic recording medium. The information recorded on the magnetic recording medium of the film F is read by the magnetic head, and then, is transmitted to the image processor 14 or the like; in the meantime, the information from the image processor 14 or the like is transferred to the carrier 30, and then, is recorded on the magnetic recording medium of the film F by the magnetic head.

Further, the carrier 30 is provided with a code reader for reading bar codes such as a DX code optically recorded on the film F, an extended DX code, an FNS code, and various information optically recorded on the film F. Various information read by the above code reader is transmitted to the image processor 14.

As described above, the reading light is a projection light transmitting through the film F held by the carrier 30 and bearing an image. The projection light is imaged on a light receiving surface of the image sensor 34 by the imaging lens unit 32.

The above image sensor 34 is a so-called three-line color CCD sensor having three line CCD sensors for reading an R image, a G image and a B image, respectively, and extends in the main scanning direction. The projection light of the film F is separated into three primary colors, that is, R, G and B by the image sensor 34, and thereafter, is photoelectrically read.

An output signal of the image sensor 34 is amplified by the amplifier 36, converted into a digital signal by the A/D converter 38, and thereafter, transmitted to the image processor 14.

In the scanner 12, the image photographed on the film F is read twice by pre-scan for reading the image at a low resolution and fine-scan for obtaining an image data of the output image.

The above pre-scan is performed according to a pre-scan reading condition, which is preset so that all film images read by the scanner 12 are read as input images without saturating the image sensor 34. On the other hand, the above fine-scan is performed according to a fine-scan reading condition, which is preset for each frame based on the pre-scan data so that the image sensor 34 is saturated at a density slightly lower than the lowest density of the image (frame). Consequently, the output signals from the pre-scan and the fine-scan merely differ in resolution and output level.

Incidentally, in the present invention, the scanner 12 is not limited to the slit scan type as described above, and may be a type of reading the entire plane of the image in one frame at a time, that is, surface exposure. In this case, for example, an area CCD sensor is used, and each color filter of R, G and B is interposed in succession between the light source and the film F so as to read the image by the area CCD sensor. By doing so, the image photographed on the film is separated into three primary colors to be read in succession.

As described above, the output signal (image data) from the scanner 12 is output to the image processor 14.

In the print system 10 of the present invention, the image processor 14 may receive, in addition to the image of the film F read by the scanner 12, the image data from various image data supply sources and performs the processing described later. The supply sources include an image processor for reading a reflected original image, image pickup devices such as digital camera and digital video camera, communication device such as LAN (Local Area Network) and computer communication network, various reading device and image pickup device of media (recording medium) such as a memory card, an MO (magneto-optical recording medium) and a photo CD, and image data storage device.

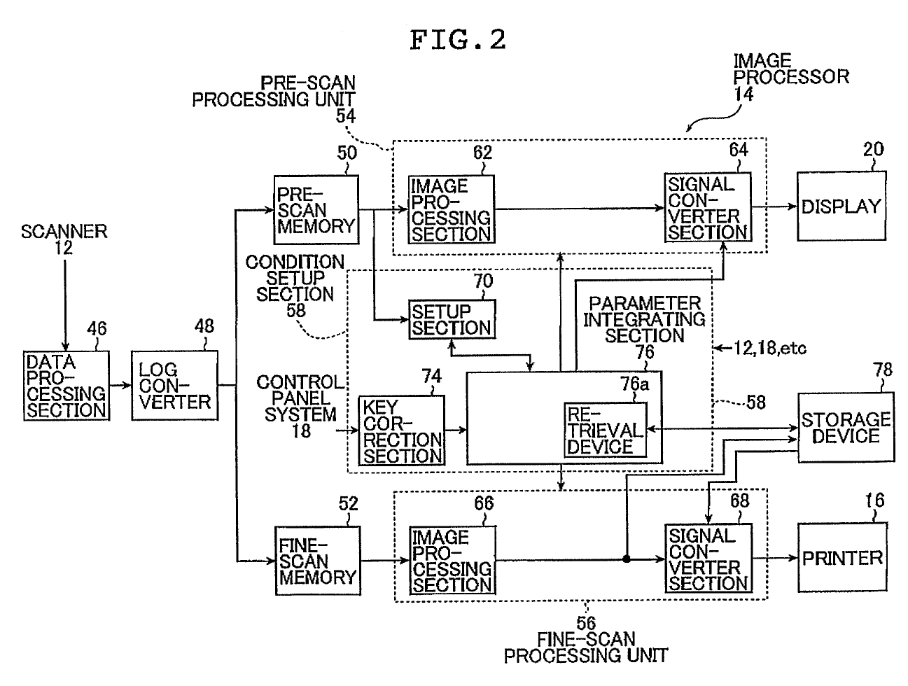

FIG. 2 is a block diagram schematically showing a structure of image processor 14 according to one embodiment of the first aspect of the present invention (hereinafter, referred to as first embodiment).

According to this first embodiment, image processing conditions for each image processed in the simultaneous printing, image retrieval data for retrieving the image processing condition, and compressed image data obtained by compressing image data after the above processing are stored as image reproducing information (the simultaneous printing information) to be used in the simultaneous printing. When a reprinting instruction is given, a film is scanned to input a designated image, and thereafter, image processing is performed to the designated image input from the above film with the same image processing condition as in the simultaneous printing and the image processing condition retrieved by using the image retrieval data corresponding to the designated image. By doing so, a reprint is made.

As shown in FIG. 2, an image processor 14 is equivalent to image processing device of the present invention. The image processor 14 includes a data processing section 46, a Log converter 48, a pre-scan (frame) memory 50, a fine-scan (frame) memory 52, a pre-scan processing unit 54, a fine-scan processing unit 56, and a condition setup section 58.

Incidentally, FIG. 2 mainly shows sections relative to image processing; the image processor 14 further includes a CPU for carrying out the control and management of the entire print system 10 including the image processor 14, a memory for storing information required for operating the print system 10, and device for determining a numerical aperture of the variable diaphragm 24 and a an accumulating time of the image sensor 34. Moreover, the control panel system 18 and the display 20 are connected to each section via the CPU (CPU bus) and the like.

In the data processing unit 46, each of R, G and B output signal output from the scanner 12 is subjected to predetermined processings such as DC offset correction, dark correction and shading correction, and thereafter, converted into digital image data by the Log converter 48. A pre-scan (image) data and a fine-scan (image) data are stored in the pre-scan memory 50 and the fine-scan memory 52, respectively.

The pre-scan data stored in the pre-scan memory 50 is processed by the pre-scan processing unit 54 so as to be output as image data corresponding to a display by the display 20. On the other hand, the fine-scan data stored in the fine-scan memory 52 is processed by the fine-scan processing unit 56 so as to be output as an image data corresponding to the output by the printer 16.

In this case, the pre-scan processing unit 54 includes an image processing section 62 and a signal converter section 64; on the other hand, the fine-scan processing unit 56 includes an image processing section 66 and a signal converter section 68.

The image processing section 62 of the pre-scan processing unit 54 and the image processing section 66 of the fine-scan processing unit 56 are both sections for carrying out image processing to the image (image data) read by the scanner 12 in accordance with a setup by a condition setup unit 58, which will be described later. The above two image processing sections 62 and 66 perform almost the same processing but with different pixel densities of the image data to be processed.

An image processing in the image processing sections 62 and 66 may be any one of known image processings, and one or more of the following image processings are exemplified; gray balance adjustment, gradation adjustment, density adjustment (color density correction), electronic scaling processing, sharpness processing, grain restraint processing, dodging processing (for imparting a dodging effect in direct exposure print system by image data compression keeping intermediate gradation), correction on geometric distortion, correction on brightness of the edge of image field, correction on red-eye effect, special finishing such as soft focus, black and white finishing, and the like.

These processings may be performed by known methods, and are performed by using a proper combination of processing operation (algorithm), processing by adder and subtracter, processing by LUT (look-up table), matrix (MTX) calculation, filter processing and the like.

The signal converter section 64 of the pre-scan processing unit 54 is a section for converting the image data processed by the image processing section 62 by using a 3D (three-dimension)-LUT and the like so as to obtain an image data corresponding to the display by the display 20. On the other hand, the signal converter section 68 of the fine-scan processing unit 56 is a section, by using the 3D-LUT and the like, to convert the image data processed by the image processing section 66 into an image data corresponding to the image record by the printer 16 and supplying it to the printer 16.

The processing conditions in the above two converter sections 64 and 68 are set by the condition setup unit 58.

The image processing to be performed in the pre-scan processing unit 54 and the fine-scan processing unit 56 and the processing conditions therein are set by the condition setup unit 58.

The condition setup unit 58 includes a setup section 70, a key correcting section 74 and a parameter integrating section 76 having retrieval device 76a. The parameter integrating section 76 is connected with a storage device 78 for storing image reproducing information (usually, the simultaneous printing information). In this case, the image reproducing information (the simultaneous printing information) is information for carrying out the same image (image data) processing as performed in the simultaneous printing for reprinting. More specifically, the image reproducing information is an image processing condition for each image processed in the simultaneous printing, and image retrieval data for retrieving the image processing condition, or compressed image data obtained by compressing the image data. Incidentally, in the second and third embodiments described later, the image reproducing information includes image data after image processing (image data after setup), which is processed by the image processing section 66 in the simultaneous printing, and is not yet converted by the signal converter section 68.

The image processing condition may be information capable of reproducing the image processing condition in the simultaneous printing. More specifically, the information includes an LUT and an operational equation prepared for image processing, a coefficient relative to the predetermined image processing and information on DCMY key correction by an operator.

The image retrieval data is a data used in the case where the image retrieval device 76a retrieves the image reproducing information stored in the storage device 78; namely, the image retrieval data is simply a numerical value, and not image data. By using the image retrieval data, an image is specified among several hundreds of thousands of frames, for example.

Moreover, the compressed image data is used for displaying the image retrieval result on the display 20 in order to confirm whether or not correct image data is accessed by the retrieval, and a high quality picture is not required. Of course, no compression may be made; in this case, however, it is desirable to compress the image data considering the capacity of a hard disk. Incidentally, the compression method is not specially limited, and for example, JPEG, JPEG2000, Flash Pix, TIFF and the like are preferably employed.

In the case where it seems that the retrieval result is not correct, several frames may be displayed as candidate images on the display 20, and thereafter, the operator may select the correct image from them.

When no display of the retrieval result is made, the compressed image data have no need to be saved; therefore, it is possible to reduce memory capacity by the above saving, and to improve a processing speed. Moreover, in the case of saving the compressed image data, it is effective to fetch the above-mentioned image retrieval data from the compressed image data as image characteristics data. For example, a DC (direct current) component of spatial frequency data made by discrete cosine transformation (DCT) may be used as the image retrieval data, that is, the image characteristics. Further, the image data is divided into blocks having predetermined dimensions, and then, an average value, or the sum or the maximum value, and the minimum value of the blocks may be used.

When the print is made, the image reproducing information (the simultaneous printing information) is stored in the storage device 78. Usually, this is performed in so-called the simultaneous printing reproducing and outputting the image photographed on the photographic film. In this embodiment, this is referred to as the simultaneous printing, and others are referred to as reprinting. Of course, in the former reprinting, the image reproducing information (the simultaneous printing) may be stored in the storage device 78, and then, may be used in the latter reprinting. Namely, in this first embodiment, in the former printing such as the simultaneous printing and the former reprinting, the image reproducing information is stored in the storage device 78, and thereafter, is used in the latter printing such as the reprinting and the latter reprinting. In particular, the simultaneous printing and the reprinting will be described below as typical examples.

The setup section 70 determines a fine-scan reading condition and image processing contents and a condition in the pre-scan processing unit 54 and the fine-scan processing unit 56. More specifically, the setup section 70 makes a density histogram, and calculates the following image characteristics from pre-scan data in the simultaneous printing, and thereby, sets a fine-scan reading condition. The image characteristics include an average density, a predetermined percentage (%) point of the frequency of density histogram such as high light (lowest density) and shadow (highest density), LATD (Large Area Transmittance Density), histogram maximum and minimum values. Further, the setup section 70 determines image adjustment to be executed and execution order from various image processings in accordance with the density histogram, image characteristics and an operator's instruction, further, calculates each image processing condition and a converting condition by the signal converter section 68, and thereafter, supplies them to the parameter integrating section 76.

The key correcting section 74 calculates an adjusting amount of image processing condition in accordance with instructions for color adjustment, density adjustment and contrast (gradation) adjustment and such, which are input from the keyboard 18a and the mouse 18b of the control panel system 18, and then, supplies it to the parameter integrating section 76.

The parameter integrating section 76 receives the image processing condition calculated by the setup section 70, and sets it to the predetermined sections of the pre-scan and fine-scan processing units 54 and 56, and further, adjusts an image processing condition set in each section in accordance with the adjusting amount calculated by the key correcting section 74.

Further, in the simultaneous printing, the parameter integrating section 76 determines processing suitable to the frame, and thereafter, transmits the image reproducing information of the frame to the storage device 78. In the reprinting, the parameter integrating section 76 retrieves the storage device 78 by using the retrieval device 76a so as to read an image reproducing information of the frame to be reprinted, and then, supplies required information to the predetermined sections such as the setup section 70 while displaying the retrieval result on the display 20.

The storage device 78 storing the image reproducing information and the retrieval device for retrieving the image reproducing information stored in the storage device 78 are not specially limited, and various devices may be applicable.

For example, the storage device 78 may be exemplified by any recording medium such as hard disk and database built in or connected to the image processor 14, a floppy disk, a magneto-optical recording medium. Moreover, the print system 10 may be connected with an external database by communication device such as a computer communication network.

In addition, the retrieval device 76a may be structured as a hardware such as conventionally known retrieval IC, LSI or ASIC, or may be structured as conventionally known retrieval software to be installed in the parameter integrating section 76.

The image data processed in the pre-scan processing unit 54 of the image processor 14 is transmitted to the display 20; on the other hand, the image data processed in the fine-scan processing unit 56 of the image processor 14 is transmitted to the printer 16.

The printer 16 includes a laser exposure unit (printing device) 16a, which exposes the photosensitive material 17 in accordance with the supplied image data so as to record a latent image, and a processor (developing device)(not shown), which performs the predetermined processing to the exposed photosensitive material, and outputs it as a print. Further, the printer 16 has a back-printing device 16b for printing the predetermined information to the back of the print.

In the printer 16, the photosensitive material 17 is cut into a print length, and thereafter, back-printing is recorded by the back-printing device 16b. Subsequently, three kinds of light beams such as R exposure, G exposure and B exposure are modulated by the laser exposure unit 16a in accordance with the image data output by the image processor 14 so as to be deflected to a main scanning direction. Simultaneously, the photosensitive material is transported in the sub-scanning direction orthogonal to the main scanning direction. By doing so, the photosensitive material 17 is two-dimensionally scanned and exposed to read a latent image, and thereafter, is supplied to the processor. After receiving the photosensitive material 17, the processor performs predetermined wet development processings such as a color forming development, bleach-fixing and rinsing, and then dries the photosensitive material to obtain a print; the processor sorts the obtained print into a predetermined unit such as a roll of film, and thereafter, accumulates it.

Now, each process in the case of a 135-size film and in the case of an APS 240-size film of this first embodiment will be described in detail.

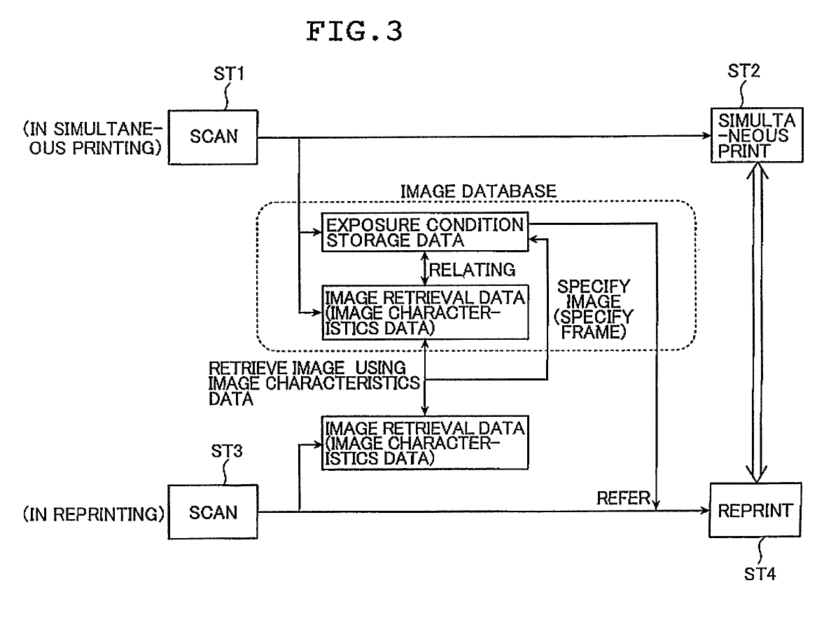

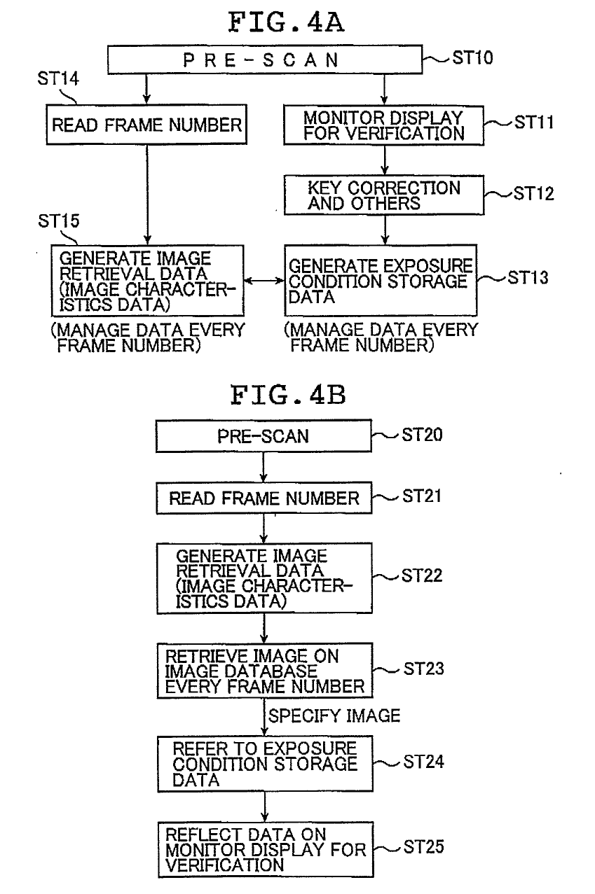

First, the case of a 135-size film will be described below. FIG. 3 schematically shows the entire flow of processes in the case of a 135-size film, FIG. 4A schematically shows the flow in the simultaneous printing of the 135-size film, and FIG. 4B schematically shows the flow in the reprinting thereof.

In this case, the simultaneous printing is mainly described in connection with making and saving the image reproducing information such as the image retrieval data, while the reprinting is in connection with retrieving an image that is designated for reprinting using the image retrieval data; the descriptions regarding the normal image processing are omitted.

As shown in FIG. 3, in the case of the simultaneous printing, the film is scanned (pre-scanned and fine-scanned) in Step ST1 as usual so that image data is read. Then, normal image processing is performed, and image reproducing information such as image retrieval data is generated and stored in the database of the storage device 78. In Step ST2, the simultaneous print is output by the printer, 16. On the other hand, in the case of the reprinting, in Step ST3, the film is scanned (pre-scanned) so as to generate image retrieval data, with which the retrieval device 76a retrieves an image so as to specify a reordered image. Subsequently, the retrieval device 76a calls the image processing condition used in the simultaneous printing of the image from the database, and then, the film is again scanned (fine-scanned) so as to obtain image data, which is subjected to the image processing with the same image processing condition as in the simultaneous printing, and thereafter, in Step ST4, the image data is output as a reprint.

The above processes will be described further in detail below with reference to FIG. 4A and FIG. 4B.

In the case of the simultaneous printing, as shown in FIG. 4A, first, in Step ST10, the operator mounts a carrier corresponding to the film F to a predetermined position of the scanner 12 so that the film F is pre-scanned. After the pre-scan data is read, the setup section 70 made a density histogram and calculates image characteristics from the read pre-scan data, then calculates the reading condition and the image processing condition for the fine-scan, and thereafter, the parameter integrating section 76 sets the image processing condition to each predetermined section.

Based on the condition thus set, predetermined image processing is performed in the pre-scan processing unit 54 and in Step ST11, an image for verification is displayed on the display 20 (monitor for verification).

Sequentially, in Step ST12, the operator watches a verification screen on the display 20 so as to verify (confirm) the image, and then, as the need arises, makes adjustment (correction) on color, density and gradation using an adjustment key preset in the keyboard 18a. The adjustment signal is transmitted to the key correcting section 74. The key correcting section 74 calculates a correcting amount on the image processing condition corresponding to the input, and then, transmits it to the parameter integrating section 76. The parameter integrating section 76 makes corrections on the image processing condition set in the processing sections 62 and 66 in accordance with the given correcting amount. Therefore, the image displayed on the display 20 changes in accordance with the input by the operator.

Next, in Step ST13, exposure condition storage data is generated from the finally determined image processing condition.

On the other hand, in Step ST14, a frame number is read from the film F while the above processing is performed. The image processing condition for the image of each frame is managed with the each frame number. In Step ST15, the parameter integrating section 76 generates the image reproducing information corresponding to each frame number, and then, transmits it to the storage device 78 so that the generated image reproducing information is stored as database in the storage device 78.

The image reproducing information is image retrieval data, an image processing condition or compressed image data, and it is effective to use image characteristics data taken when generating the compressed image data as the image retrieval data. Further, preferably, the image reproducing information comprising the above data is related to at least every one or more of the following information, and may be managed on the database. More specifically, the information includes frame number, kind of film, machine type of camera, customer, order, film format (ASP, 135, Brownie, etc.), type of film carrier, film mask, year/month/day/time of when photographed, image format (BMP, JPEG, etc.) and order terminal equipment.

In this case, the above year/month/day/time of when photographed may be read from the image. Moreover, as described above, the image reproducing information is related to as many kinds of information as possible, to thereby enable to improve a retrieval processing speed and ato reduce errors in retrieving.

In the manner as described above, when the image processing condition is set, the photographic film is fine-scanned so as to obtain the image data. Then, as usual, in the image processing section 66 of the fine-scan processing unit 56, image processing is performed to the obtained image data according to the above set image processing condition. The image data thus obtained after image processing is output as a print (the simultaneous print) reproducing the image photographed on the film from the printer 16.

As described above, in this first embodiment, the image reproducing information is generated in the simultaneous printing, and thereafter, is stored in the storage device 78 In the print system of the present invention, the operation of storing the image reproducing information in the storage device 78 is not limited to the case of the simultaneous printing. For example, the above process may be performed in the case where the customer has a complaint against the image of the simultaneous printing, and makes a reprinting order with corrections in color/density, and the case of the image processing when a frame storing no image processing information is printed.

Moreover, the compressed image data is used for displaying the retrieval result on the display 20 in retrieving. If the display is not necessary in particular, there is no need of storing the compressed image data; therefore, it is possible to reduce a memory capacity by the above saving. For this reason, it is preferable to give a selection as to whether or not the compressed image data is stored. In this case, the selection may be made in every the simultaneous printing; however, this is not the sole case, and when the system is located, the selection may be previously made as to whether or not the compressed image data should be stored.

Moreover, when storing the image reproducing information, the number of frames of storable image reproducing information may be set mainly in accordance with CPU performance, hard disk capacity and resource, and further, the number of frames thus set may be changed. For example, the number of frames may be set based on the residual capacity of hard disk in resource check when a program is installed.

Using the image characteristics data as the image retrieval data, the image processing condition and the image characteristics data may be stored separately, or may be stored as the image reproducing information in a set of packing and relating the image processing condition and the image characteristics data. The image processing condition may be any other form so long as it is information capable of reproducing the simultaneous print; in this case, the date, customer's number and the like may be more preferably added to the information.

The image retrieval data, image processing condition and compressed image data constituting the image reproducing information are related to each other, and when any one of these data is deleted, the rest thereof is deleted, and when any one of these data is updated, the rest thereof is updated, allowing to always store and manage only required information, and to save storage capacity, and thus, to perform an effective operation. The update of the image reproducing information may be made in the following manner. For example, in the reprinting, in the case of further adding a new condition to the previous processing condition without using the image processing condition of the accessed image reproducing information in order to improve the image quality more than the previous print, the latest information is updated and stored.

Moreover, preferably, the image reproducing information, the image retrieval data and the compressed image data are backed up at a predetermined timing. The predetermined timing is not specially limited and the following timings are preferably exemplified as follows; system startup, startup inspection, finishing inspection, system shutdown, system hang-up, time when instruction is given by the operator, software version up, and the like.

Next, in the case of the reprinting, as shown in FIG. 4B, firstly, in Step ST20, the film F is pre-scanned by the scanner 12, and then, an image designated for reprinting is read. In Step ST21, a frame number is read from the film F. The read pre-scan data is transmitted to the image processor 14 together with the frame number. In Step ST22, the setup section 70 calculates the image characteristics data from the pre-scan data so as to generate image retrieval data.

Sequentially, in Step ST23, the retrieval device 76a of the parameter integrating section 76 retrieves the database stored in the storage device 78 using the image retrieval data, and then, specifies an image designated for reprinting. In Step ST24, the retrieval device 76a accesses the image reproducing information including the image processing condition used in the simultaneous printing of the specified image, and thereafter, refers to the exposure condition storage data.

Sequentially, in Step ST25, the retrieval result is displayed on the display 20 using the image reproducing information such as the accessed compressed image data, and then, the operator confirms the retrieval result. The operator watches the retrieval result display, and then, if a judgment is made such that the retrieval result is correct, the fine-scan is performed in order to obtain an image data for reprinting. The obtained image data is subjected to the same image processing as in the simultaneous printing using the above retrieved image processing condition (exposure condition storage data), and consecutively to the processing mainly using the 3D-LUT; thereafter, a reprint is output.

If the retrieval object is not found, or if an error in retrieving is made, it is preferable that the images listed as the second candidate and the following or the instruction for retrieving the image again is displayed on the display 20. The operator watches the retrieval result display, and then, performs the retrieval operation again if the retrieval result is not correct.

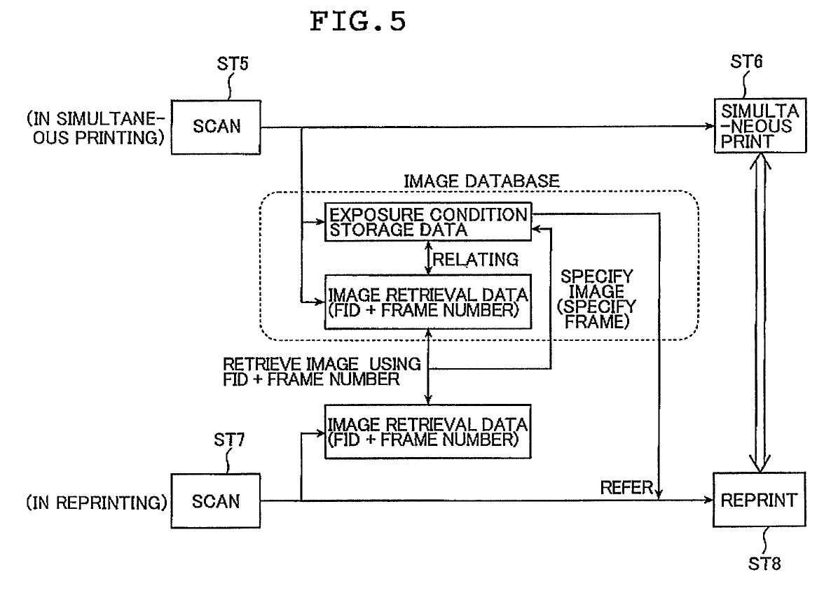

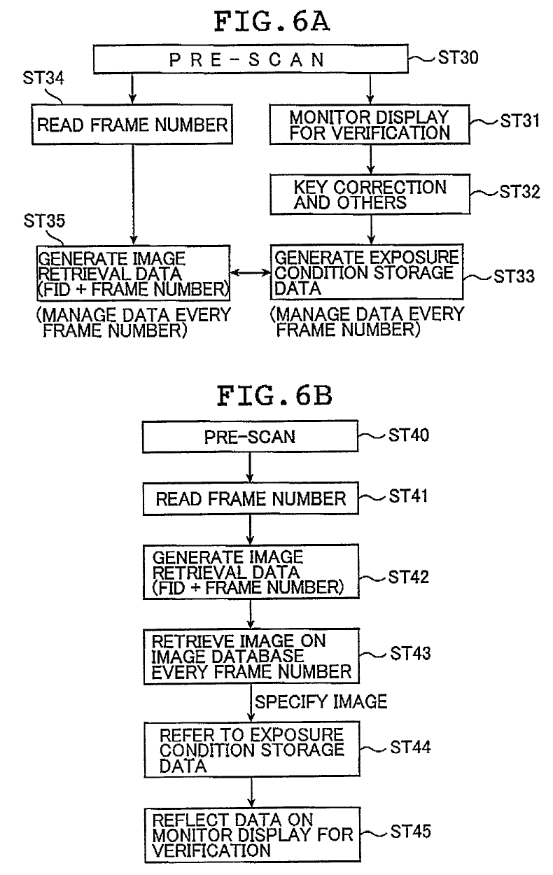

The following is a description on the case of an APS 240-size film. FIG. 5 schematically shows the entire flow of processes in the case of a 240-size film, FIG. 6A schematically shows the flow in the simultaneous printing of the 135-size film, and FIG. 6E schematically shows the flow in the reprinting thereof.

As shown in FIG. 5, the flow of processes is roughly the same as the case of the above 135-size film, except that the image is retrieved using a film ID and a frame number. other is the same as the case of the above 135-size film, and the normal print generating operation is performed.

As shown in FIG. 5, in the case of the simultaneous printing, in Step ST5, the film is scanned (pre-scanned and fine-scanned) as usual so as to read image data, and then, the normal image processing is performed, and thereafter, the image reproducing information such as image retrieval data is generated, and stored in the database. In Step ST6, the simultaneous print is output from the printer. On the other hand, in the case of the reprinting, in Step ST7, the film is scanned (pre-scanned) so as to read a film ID (FID) and a frame number, and then, an image is retrieved using these film ID and frame number so as to specify a reordered image. The image processing condition used in the simultaneous printing of the specified image is accessed from the database, and then, the film is again scanned (fine-scanned) so as to obtain an image data. The image data is then subjected to image processing with the same image processing condition as in the simultaneous print. In Step ST8, the image data after image processing is output as a reprint.

The above processes will be further described below in detail with reference to FIG. 6A and FIG. 6B.

As shown in FIG. 6A, in the case of the simultaneous printing, the flow of processes is same as in the case of the 135-size film. That is, as shown in FIG. 6A, the operator first mounts a carrier corresponding to the film F to a predetermined position of the scanner 12 so that the film F is pre-scanned in Step ST30 When the pre-scan data is read, the setup section 70 makes a density histogram and calculates image characteristics from the read pre-scan data, and then, calculates the reading condition and the image processing condition for the fine-scan, and thereafter, the parameter integrating section 76 sets the image processing condition to each predetermined section.

Based on the determined condition, in the pre-scan processing unit 54, the predetermined image processing is performed, and in Step ST31, an image for verification is displayed on the display 20 (verification monitor).

Sequentially, in Step ST32, the operator watches a verification screen on the display 20 so as to verify (confirm) the image, and then, as needed, makes adjustment (correction) on color, density and gradation using an adjustment key preset, etc., in the keyboard 18a. Next, in Step ST33, exposure condition storage data is generated from the verified result and the determined image processing condition.

On the other hand, in Step ST34, the film ID and the frame number are read from the film F while the above processing is performed. The image processing condition for the image of each frame is managed with the each frame number. In Step ST35, the parameter integrating section 76 generates the image reproducing information corresponding to each film ID and frame number, and then, transmits it to the storage device 78 so that the generated image reproducing information is stored as database in the storage device 78.

In the manner as described above, when the image processing condition is set, the film is fine-scanned so as to obtain the output image data. In the image processing section 66 of the fine-scan processing unit 56, image processing is performed to the obtained image data according to the above set image processing condition. By doing so, the obtained image data is output by printer 16 as a print (the simultaneous print) reproducing the image photographed on the film.

Next, in the case of the reprinting, as shown in FIG. 6B, in Step ST40, the film F is first pre-scanned so as to read an image designated for reprinting. In Step ST41, an image retrieval code (FID) comprising the film ID and the frame number given to the above image (frame) is simultaneously read. In Step ST42, the setup section 70 generates image retrieval data. In this case, the image retrieval data is the film ID (FID) and the frame number, unlike the case of the above 135-size film. Sequentially, in Step ST43, the retrieval device 76a of the parameter integrating section 76 uses the FID and the frame number as image retrieval data, and then, retrieves the database stored in the storage device 78 so as to specify the image designated for reprinting. In Step ST44, the retrieval device 76a accesses the image reproducing information corresponding to the image, and thereafter, refers to the exposure condition storage data. Therefore, in the case of the APS film, there is no need of calculating image characteristics from the read pre-scan data for the retrieval operation like in the case of the 135-size film.

Sequentially, in Step ST45, the compressed image data of the accessed image reproducing information is displayed on the display 20, and then, the operator confirms the retrieval result.

If the operator makes a judgment such that the retrieval result is correct, the fine-scan is performed this time in order to obtain an image data for reprinting. The obtained image data is subjected to the image processing, according the image processing condition (exposure condition storage data) of the above accessed image reproducing information, and then to the transformation processing by the 3D-LUT and the like in accordance with the output format of print or image data; thereafter, a reprint is output.

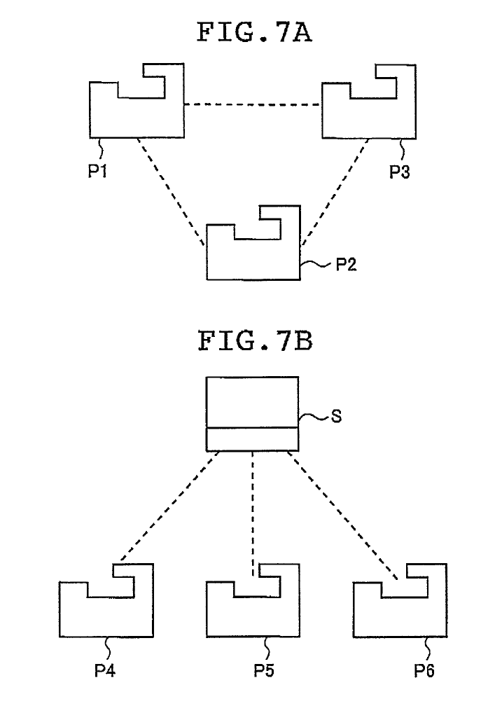

In either case of the above-mentioned 135-size and 240-size films, as shown in FIG. 7A, for example, a print system P1 is interconnected with another print system P2, P3 or the like (of the same shop or external) via communication device such as computer communication network. When retrieving the image using the image retrieval data, image retrieval data stored in the print systems connected to the network may be retrieved.

Alternatively, as shown in FIG. 7B, a plurality of print systems P4, P5 and P6 are connected with an image server S via network, and the image reproducing information of image processed by the print system of each shop is centrally managed by the image server S. When retrieving the image using the image retrieval data, the image server S may be also retrieved.

In this case, the following particular ID may be preferably given to the image reproducing information in order to facilitate the retrieval operation. The particular ID preferably includes a shop code, a machine type code, an order number for specifying an order, a frame number for specifying an image, and the like. More specifically, the shop code shows information as to whether the shop is the same as the shop that made the simultaneous printing, or is different from there, or belongs to the same chain shop, and the machine type code shows information as to whether or not the same type print system is used.

In the simultaneous printing, when the output format is a print, the particular ID is printed to the back of the print, or to the index print; on the other hand, when outputting to image file, the particular ID may be recorded into the file name, header or book file. The customer makes a reorder by either telephone or email or at the shop using the particular ID.

When a reprinting order is given, the print system P1 (in the case of FIG. 7A) or the image server S (in the case of FIG. 7B) retrieves the image reproducing information according to the particular ID.

When making the reprinting order, it is preferable that the customer may make a selection as to whether the reprint is made using the same print system as the simultaneous printing, or using another print system. In other words, the reprint may be output from the same print system as the simultaneous printing, or from another print system. In the case of outputting the reprint from another print system, the data (image processing condition, etc.) made in the simultaneous printing is taken from the print system used in the simultaneous printing or the image server, and thereafter, may be used. Of course, if there exists the print system used in the simultaneous printing, it is desirable to output the print using the print system.

As described above, when the print system is connected with another print system or the image server via network, the image reproducing information is loaded (downloaded) from another predetermined print system or image server at the predetermined timing, or makes reference thereto, and thereafter, may be used in order to make the reprint.

In this case, the image reproducing information loaded and used for the reprint is unnecessary after the image processing for making the reprint is completed; therefore, the image reproducing information may be deleted thereafter. The deleting timing is not specially limited, and for example, the deletion may be done in the finishing inspection.

According to this first embodiment, even if the reprinting order is made at the shop different from the shop that made the simultaneous print, or even if the reorder is given to the same shop and the reprint is output by the different print system, it is possible to effectively output a reprint coinciding with the simultaneous print in the image, color and density.

Next, the following is a description of one embodiment (referred to as second embodiment) of a second mode of the present invention.

According to the second embodiment, the image data is stored as image reproducing information together with an image identification code (particular ID) for specifying the image. More specifically, the image data is the processed image data that was subjected to image processing in the image processing section of the fine-scan processing unit in the simultaneous printing (image data after setup). And not yet converted corresponding to the output format by the 3D-LUT in the signal converter section (i.e., not converted in accordance with the output format). When a reprinting order is given, the designated image is retrieved from the stored data and converted corresponding to the output format so that the image is output. Therefore, in this second embodiment, there is no need of scanning (fine-scanning) the film in the reprinting like in the above first embodiment.

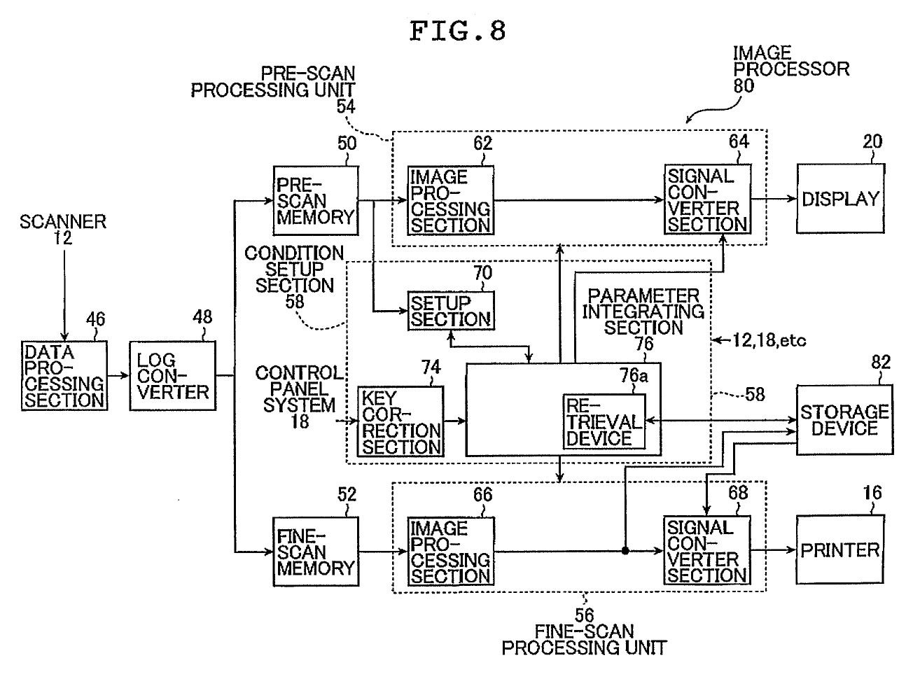

FIG. 8 is a block diagram schematically showing a structure of an image processor 80 according to the second embodiment.

Basically, the image processor 80 of the second embodiment is same as the image processor 14 of the above first embodiment, except a storage device 82. Accordingly, the identical reference numerals are given to designate the same constituent elements as the image processor 14, and the details thereof are omitted.

The second embodiment differs form the above first embodiment in the following point; in the simultaneous printing, a setup image data after being processed by the image processing section 66 and before being converted by the signal converter section 68 (after image processing) is stored in the storage device 82. Moreover, in the reprinting, the above setup image data corresponding to the image designated for reprinting is accessed from the storage device 82 and is converted by the signal converter section 68 in accordance with the output format, and thereafter, is output. The storage device 82 differs from the above storage device 78 in that the setup image data before conversion is stored as image reproducing information, and others are same as the storage device 78. Therefore, the details thereof are omitted except the differences.

Namely, according to the second embodiment, in the simultaneous printing, the normal processing is performed, and finally, before image data is converted by the 3D-LUT in the signal converter section 68, the setup (image-processed) image data before the above conversion is stored as the image reproducing information in the storage device 82. The setup image data stored as the image reproducing information is preferably an image data which is subjected to at least one of the following image processings: electronic scaling processing; color gradation; color density correction processing; sharpness processing; and dodging processing. Therefore, since the image processing has been already performed to the image data, when outputting the image data to a predetermined recording medium, the conversion by, for example, the 3D-LUT is merely performed in accordance with the output medium. Examples of the output medium include a print (photographic paper) and media such as CD-R, Jazz, Zip, and the like.

Moreover, the setup image data is preferably related to at least every one or more of the following information, and is managed on the database. The information includes frame number, kind of film, machine type of camera, customer, particular ID of image, order received year/month /day, shop receiving order, print system, order, film format (ASP, 135, Brownie, etc.), type of film carrier, film mask, year/month/day/time of when photographed, image format (BMP, JPEG, etc.) and order terminal equipment.

When storing the image data after image processing, in order to specify the image data, the image data may be stored in a state that a particular ID is added thereto. The particular ID may be given to the customer as information such as back-printing to the print and header of image file, in the simultaneous printing.

Moreover, the processed (setup) image data as the image reproducing information may be retrieved using the image retrieval data, and further, another particular ID may be provided. Namely, when storing the processed image data as image reproducing information, in order to specify the image data as image reproducing information, the image data may be stored in a state that the particular ID is added thereto. Preferably, the particular ID is given to the customer as information such as back-printing to the print and header of image file, in the simultaneous printing.

In reprinting, when the customer makes a reorder in a state of designating the particular ID for specifying the image reproducing information, the operator inputs the particular ID to the print system, and thereafter, the setup image data of the simultaneous printing is retrieved by the retrieval device 76a using the particular ID. Then, the retrieval device 76a retrieves in the database stored in the storage device 82, and when the image data having reprinting order is retrieved, the image data is accessed from the storage device 82. The signal converter section 68 converts the obtained image data in accordance with the output medium, and thereafter, outputs it.

In this case, like the above first embodiment, a range of retrieving the image reproducing information (setup image data in the simultaneous printing) and the retrieval condition may be preset. Moreover, when storing the image reproducing information, the number of frames of storable image reproducing information is set in accordance with performance and resource of the print system, and may be further changed.

Further, the print system is interconnected with another print system (same shop, or external) by communication device such as computer communication network, and thereafter, when retrieving the image data using the particular ID, the print system connected to the network may be also retrieved. Moreover, a plurality of print systems are connected via image server and network, and the setup image data processed by the print system of each shop is centrally managed by the image server, and thereafter, when retrieving the image data, the image server may be also retrieved using the particular ID. In addition, the image data may be retrieved from print systems of chain shops connected via network.

Like the above first embodiment, when making a reprinting order, the customer can select whether a reprint is made using the same print system as the simultaneous printing, or using another print system. Likewise, in the case where the print system is connected with another print system or image server via network, the image reproducing information is downloaded from another predetermined print system or image server at predetermined timing, or is made reference, and thereafter, may be used to make a reprint. In this case, the image reproducing information loaded for making the reprint is unnecessary after image processing for making the reprint is completed; therefore, the image reproducing information may be deleted thereafter.

As described above, in the second embodiment, it is possible to make a reprint coinciding with the simultaneous print in image, color/density without scanning the film.

Both above first and second embodiments are related to the image data photographed on the photographic film has been treated; of course, the present invention is not limited thereto, and is preferably applicable to a reorder of image data of the digital camera and the like.

Further, in the above first and second embodiments, in the case where the image is not retrieved using the image retrieval data or the image identification code (i.e., the corresponding image has not been found), or in the case where an error in reading the image identification code is made such situation is preferably informed. In addition, it is preferable that image processing is retried without using the image reproducing information (the simultaneous printing information).

Further, in the above first and second embodiments, the following data is preferably stored as image reproducing information in the database of the storage device 78. The data includes image data before conversion corresponding to the image processing condition of the simultaneous printing or the output format and after image processing, image retrieval data for retrieving the image-processing condition or the image data before conversion and after image processing or the image identification code, and the compressed image data. In this case, when retrieving the database of the storage device 78 using the image retrieval data or the image identification code, if the corresponding image data before conversion and after image processing exist, the image data is read out and output. On the other hand, in the case where no corresponding image data exists, but the corresponding image processing condition exists, the image processing condition may be read out, and the film may be scanned so as to obtain the image data. Then, the obtained image data may be subjected to image processing according to the read image processing condition, and thereafter, output.

Next, the following is a description on one embodiment (referred to as third embodiment) of a third aspect of the present invention.

According to the third embodiment, the following image data is stored as the image reproducing information (the simultaneous printing information). That is, the image data includes image data after image processing (setup) of each image processed in the simultaneous printing, image processing condition relative to the image, image retrieval data for retrieving the image and the image processing condition relative to the image, and compressed image data obtained by compressing the image data. When a reprinting order is given, the operator makes the judgment as to whether or not the image processing condition changes in the simultaneous printing and in the reprinting. If there is no change, the reprint is made using the image data after image processing; on the other hand, if there is a change, photographic film is newly scanned the so as to input an image receiving the request for reprinting, and then, changes the image processing condition corresponding to the image receiving the request for reprinting. Thereafter, the image is subjected to image processing according to the changed image processing condition, and a reprint is newly made.

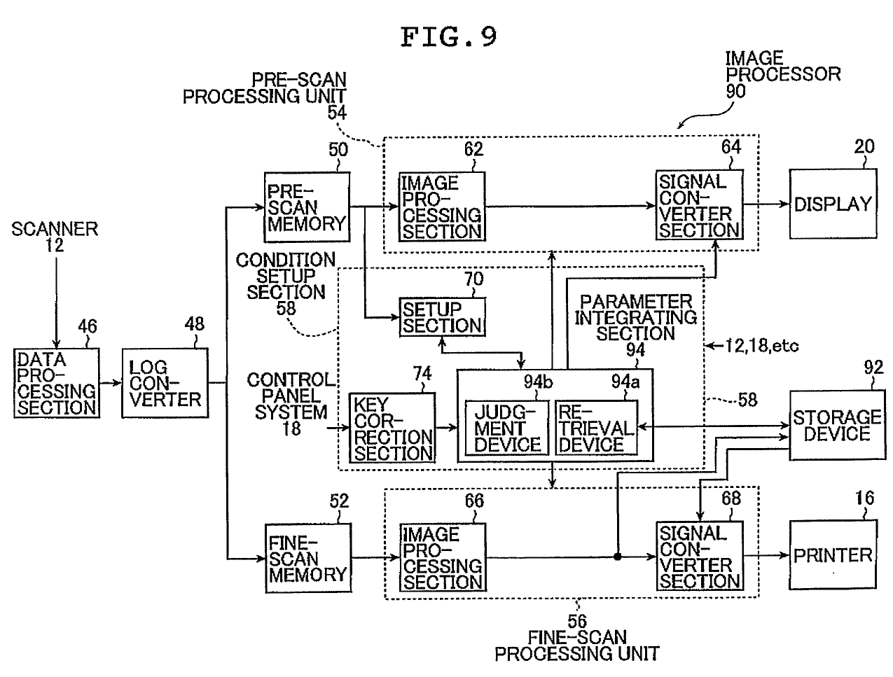

FIG. 9 is a block diagram schematically showing a structure of an image processor 90 according to the third embodiment.

Basically, the image processor 90 of this third embodiment is the same as the image processor 14 of the first embodiment, except a storage device 92 and a parameter integrating section 94. Therefore, the identical reference numerals are given to designate the same constituent elements as the image processor 14, and the details are omitted.

The third embodiment differs from the above first embodiment in the following point; the parameter integrating section 94 has a judgment device 94b in addition to the retrieval device 94a. Further, in the simultaneous printing, the parameter integrating section 94 stores setup (image-processed) image data processed in the image processing section 66 and before converted by the signal converter section 68 as image reproducing information in the storage device 92 together with the image processing condition, the image retrieval data or the compressed image data. Moreover, in the reprinting, when the judgment device 94b makes the judgment such that no change exists in the image processing condition, like in the above second embodiment, the above setup image data corresponding to the image designated for reprinting is accessed from the storage device 92 by the retrieval device 94a. Thereafter, the image data is converted by the signal converter section 68 and output in accordance with the output format.

That is, in the third embodiment, in the simultaneous printing, normal processing is performed, and before finally making conversion by the 3D-LUT or the like in the signal converter section 68, the setup image data before conversion is stored as the-image reproducing information in the storage device 92 together with the image processing condition, the image retrieval data or the compressed image data. In this case, the storage device 92 differs from the above storage device 78 in that it stores the setup image data before conversion as image reproducing information together with the image processing condition, the image retrieval data or the compressed image data. Others are the same as the above storage device 78; therefore, the details are omitted except the differences. In addition, the storage device 92 is the same as the storage device 82 of the second embodiment only in that it stores the setup image data before conversion as the image reproducing information.

In the image processor of the third embodiment shown in FIG. 9, the parameter integrating section 94 has a retrieval device 94a and a judgment device 94b. Further, the parameter integrating section 94 is connected with the storage device 92 for storing the image reproducing information (the simultaneous printing information). In this third embodiment, the image reproducing information (the simultaneous printing information) is information for reproducing the same image (image data) processing as in the simultaneous printing information. The image reproducing information includes image data after image processing (setup image data) which is processed by the image processing section 66 in the simultaneous printing and is not yet converted by the signal converter section 68. Further, the image reproducing information includes image processing condition for each image processed in the simultaneous printing, and image retrieval data for retrieving the image processing condition, or compressed image data obtained by compressing the image data.

The following is a description on the operation of the third embodiment.

Note that, the process is slightly different between the case of a 135-size film and the case of an APS film; therefore, each process will be described with reference to individual flowcharts.

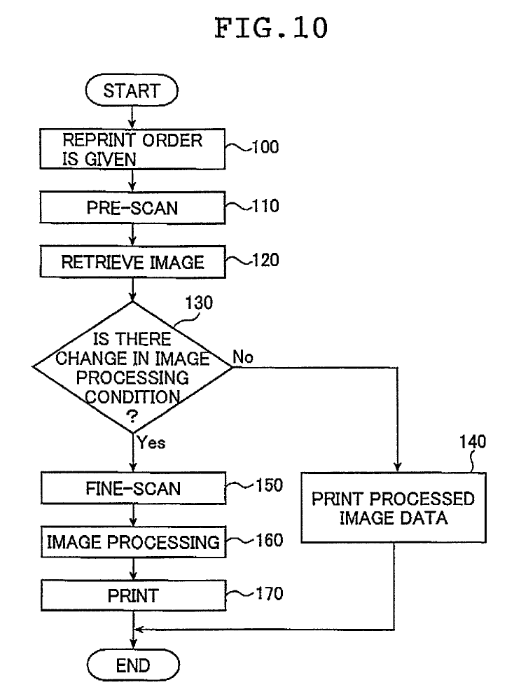

First, FIG. 10 shows the rough flow of processes in the case of a 135-size film.

As shown in FIG. 10, in Step 100, if the customer makes a reprinting order, in Step 110, on the laboratory side, the operator sets a film to the scanner 12 so as to pre-scan it. Sequentially, in Step 120, based on the customer's order, the retrieval device 94a of the parameter integrating section 94 of the image processor 90 retrieves an image designated for reprinting in the storage device 92. In the case where the customer designates the image to be reprinted, and makes the reprinting order, the reprinting order is often made in the following manner. Namely, the customer brings the photographic film (negative film) into the laboratory, designates the frame of the film, and thereafter, makes a reprinting order. The reorder method is not specially limited, and various reorder methods are employed; for this reason, there are various retrieval methods in accordance with the reorder method.

For example, the image retrieval method includes a method of using a verification screen in normal image processing, and a method of using a screen (reorder screen) only for reorder.

According to the method of using the normal verification screen, first, the operator inserts the photographic film F brought by the customer into the carrier 30 so as to pre-scan it, as described above. Then, normal setup processing is performed to the read pre-scan data, and thereafter, the images in usually every six (6) frames are displayed on the display 20 as verification monitor display. The operator selects and designates a frame to be reprinted with the keyboard 18a or the like on the verification screen. With respect to the frame thus designated, the parameter integrating section 94 retrieves the database of the storage device 92 using the image characteristics data calculated by the setup section 70 as image retrieval data. Then, if the image processing condition and the compressed image data of the simultaneous printing corresponding to the image are stored in the database, the parameter integrating section 94 accesses the compressed image data, and thereafter, displays it on the display 20 via the signal converter section 64.

On the other hand, according to the method of using the reorder screen, the operator inserts the photographic film into the carrier so as to pre-scan it, and then, operates the keyboard 18a or the like so that the reorder screen is displayed on the display 20. The reorder screen is a screen specialized so that the reorder is easy to be made. The operator selects and designates the frame to be reprinted on the reorder screen. With respect to the frame thus designated, in the same manner as the above method, the parameter integrating section 94 retrieves the database of the storage device 92 so that the image reproducing information for the frame is obtained. After the image is retrieved by the retrieval device 94a, the display screen is shifted from the reorder screen to the normal verification screen on the display 20.

In either of the above cases, image processing is performed to the acquired image reproducing information, that is, the pre-scan data read by the image processing condition of the simultaneous printing, then, the pre-scan data is again displayed on,the display 20, and thereafter, the retrieval result is reflected as verification monitor display. As a result, it is possible to confirm the image of the simultaneous printing. In the case of the 135-size film, pre-scan (or scan equivalent to pre-scan) must be performed in order to retrieve the image.

Note that, in the case of displaying the image retrieval result on the display 20, if the retrieval object is not found, or if an error in retrieving is made, it is preferable that the image after the second candidate is displayed, or the instruction for retrieving the image again is given.

Sequentially, in Step 130, the judgment device 94b of the parameter integrating section 94 makes a judgment as to whether or not the image processing condition changes between the simultaneous printing (previous time) and the reprinting (present time), with respect to the frame.

The judgment method by the judgment device 94b is not specially limited. For example, as described above, the image is retrieved on the reorder screen, and then, the image processing condition of the simultaneous printing is accessed, and thereafter, the operator adds modification to the accessed image processing condition. In this case, the parameter integrating section 94 makes a judgment such that there is a change in the image processing condition.

Moreover, when a comparison is made between the image processing condition of the simultaneous printing obtained from the image retrieval result and the present reorder information, the condition is different as follows. That is, in the simultaneous printing, an L size is designated; on the other hand, in the reprinting of the present time, a 2L size is designated. In this case, in response to meeting the requirements, the image processing condition must be changed. Therefore, the judgment device 94b of the parameter integrating section 94 makes a judgment such that there is a change in the image processing condition. The above reprinting information is input from the control panel system 18 by the operator receiving the order from the customer at the laboratory for example, or is directly input to the print system if the customer makes an order via communication network such as Internet.

When the judgment device 94b makes a judgment such that there is no change in the image processing condition, in Step 140, the reprint is made using the image-processed image data stored in the database.

On the other hand, when the judgment device 94b makes a judgment such that there is a change in the image processing condition, in Step 150, the photographic film is newly scanned (fine-scanned) so as to obtain a fine-scan data. Then, in the next Step 160, image processing is performed to the obtained fine-scan data using the changed image processing condition. Finally, in Step 170, the reprint is made.

In this case, the reprint is not always output as a so-called (photographic) print, but the case is included where it is output to a predetermined recording medium as image data. Further, in the case of outputting the reprint as a print, when the reorder is made, back pint showing the retrieval result of the image reproducing information is given to the print. As a result, it is possible to use the back-printing for confirmation after the reprint output and for reference after the reorder is again made.

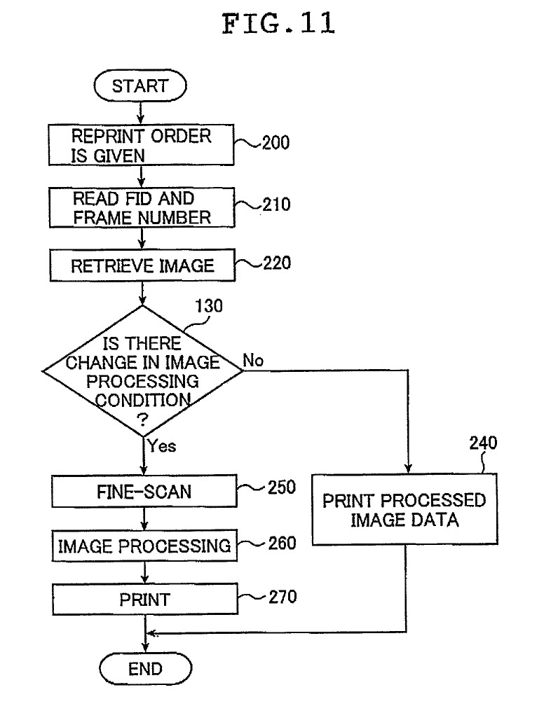

FIG. 11 shows the rough flow of processes in the case of an APS film.

In the case of the ASS film, FID (film ID) and frame number can be merely read without carrying out the pre-scan, whereby, the judgment device 94b can retrieve an image, unlike the case of the above 135-size film. Therefore, in the case of the APS film, as shown in FIG. 11, in Step 200, when the customer makes a reprinting order, in the next Step 210, the FID and the frame number are read. Sequentially, in Step 220, the image is retrieved using these information described above.

Thereafter, in Step 230, the judgment device 94b makes a judgment as to whether or not the image processing condition changes between the simultaneous printing (previous time) and the reprinting (present time). If there is no change, in Step 240, the image-processed image data is output as a print; on the other hand, if there is a change, in Step 250, fine-scan is performed, and then, in Step 260, the image processing is performed according to the changed image processing condition, and thereafter, in Step 270, the print is output.

In this third embodiment, in the case where there is a change in the image processing condition, the photographic film is scanned (fine-scanned) necessarily and newly so as to obtain image data, and thereafter, image processing is performed to the obtained image data according to the changed image processing condition. In the case where there is a change in the image processing condition, if the change is extremely small in the preset allowable range, the reprint may be output using the stored image-processed image data without scanning the film.

Here, the image processing condition device conditions that influences mainly on the image structure processing; for example, enlargement and reduction of print size are exemplified. Although the preset allowable range is not specially limited, the following various allowable ranges are given; the enlargement of print size is allowable if all is a change relating to image processing condition required for film scan, and the reduction thereof is allowable if all relates to a small change in the allowable range. On the other hand, there are the gentle condition such that the enlargement less than 10% is allowable, and the severe condition such that only reduction by 10% or less is allowable in the reduction of print size.

In the case of the print system having no pre-scan (only fine-scan), the image retrieval data may be generated from the fine scan. Further, the image may be retrieved from the result read by a pre-sensor.

The following is a description on the process of this third embodiment including the simultaneous printing.

The flow of processes of the simultaneous printing and the reprinting of this third embodiment is substantially same as the above first embodiment in the case where there is a change in the image processing condition in the reprinting and the photographic film must be scanned. That is, the case of the 135-size film is same as that of FIG. 3, FIG. 4A and FIG. 4B; on the other hand, the case of the APS 240-size film is the same as that of FIG. 5, FIG. 6A and FIG. 6B. Therefore, the details are omitted, and only differences will be described below.

In the case of the simultaneous printing of the 135-size film shown in FIG. 3, in Step ST1, the film is scanned as usual so as to read the image data. Then, normal image processing is performed so as to generate the image retrieval data, and image-processed image data before output format conversion and the image retrieval data and the like are stored as the image reproducing information in the database of the storage device 92. In Step ST2, the simultaneous print is output from the printer 16. On the other hand, in the case of the reprinting, in Step ST3, the film is scanned (pre-scanned) so as to generate image retrieval data, and then, the retrieval device 76a retrieves an image using the image retrieval data so as to specify a reordered image. Further, the image processing condition in simultaneous printing of the image is accessed from the database. Thereafter, as described above, the judgment is made as to whether or not there is a change in the image processing condition between the simultaneous printing and the reprinting. If there is a change in the image processing condition, the film is again scanned (fine-scanned) so as to obtain image data. Sequentially, image processing is performed to the obtained image data according to the changed image processing condition, and thereafter, in Step ST4, the image data is output as a reprint.

The above process will be described in more detail below with reference to FIG. 4A and FIG. 4B.

In the case of simultaneous printing shown in FIG. 4A, the processes from Step ST10 to Step ST14 are same as those in the first embodiment, In Step ST15, the parameter integrating section 94 generates the image reproducing information such as image retrieval data corresponding to each frame number, and then, transmits it to the storage device 92 so that the image reproducing information is stored in the database of the storage device 92.

In the above step, when the image processing condition is set, the film is fine-scanned as usual; on the other hand, in the image processing section 66 of the fine-scan processing unit 56, image processing is performed according to the set image processing condition. Then, the image-processed image data (setup image data) is converted into a format corresponding to the recording medium by the signal converter section 68, and thereafter, the image data is output as a print (the simultaneous print) reproducing the photographic image photographed on the film.

On the other hand, image-processed image data (image-processed image data (hereinafter, referred to as processed image data) before output format conversion) before converted by the signal converter section 68, is stored in the storage device 92 as image reproducing information in the case of making the simultaneous print.

The processed image data, the image retrieval data, the image processing condition and the compressed image data constituting the image reproducing information are related to each other like in the above first embodiment. When any one of these data is deleted, the rest thereof is deleted; on the other hand, when any one of these data is updated, the rest thereof is updated. As a result, it is possible to always store and manage only required information, to save storage capacity, and to thereby perform an effective operation.

In this case, the above image reproducing information is stored for only a predetermined period, and after the elapse of the predetermined period, only the image retrieval data, the image processing condition or the compressed image data of the image reproducing information is stored, and the image data after image processing is erased. As a result, it is possible to effectively use the memory.

Preferably, the predetermined period storing the processed image data is preset by the operator. The predetermined period is not specially limited, and for example, it is preferable to set six months or one year after the simultaneous printing, that is, a period having a possibility that the customer makes the reprinting order.

For example, in the case where a period of three months is set as the predetermined period, if the reorder is given within three months from the simultaneous printing, the image data is still stored; therefore, it is possible to receive the reorder without requiring the film. On the other hand, after the elapse of three months, the image data is output using the image retrieval data, the image processing condition or compressed image data; for this reason, the film is required for the reorder.

Next, the processes from Step ST20 to Step ST24 of the reprinting shown in FIG. 4B are the same as that of the first embodiment.

In Step ST25, the retrieval operation by the retrieval device 94a is performed using the image reproducing information such as the accessed compressed image data, and the retrieval result is displayed on the display 20 so as to confirm the retrieval result. If the retrieval object is not found, or if an error in retrieving is made, the image after the second candidate or the instruction for retrieving the image again is displayed on the display 20. The operator watches the retrieval result display, and then, performs the retrieval operation again if the retrieval result is not correct.

When the judgment device 94b of the parameter integrating section 94 makes a judgment such that there is a change in the retrieved image processing condition of the simultaneous printing and the image processing condition of the reprinting input by the operator, a message informing the above information is displayed on the display 20. Then, the instruction for carrying out fine-scan is given.

Subsequently, the fine-scan is performed so as to obtain image data for making a reprint; on the other hand, image processing is performed using image processing condition changed from the retrieved image processing condition (exposure condition storage data), and then, the reprinting image data is generated.

In accordance with the output format of print, image data, or the like, the processing by mainly the 3D-LUT is performed, and thereafter, the reprint is output. In this case, as described before, back-printing showing the retrieval result of the image reproducing information of the reprinting is given to the print by the back-printing device 16b.

The following is a description on the case of an APS 240-size film.

In the case of the APS 240-size film of the simultaneous printing shown in FIG. 5, the film is scanned (pre-scanned and fine-scanned) as usual so as to read an image data, and then, the normal image processing is performed in Step ST5. Thereafter, the processed image data, the image retrieval data and the like are stored as the image reproducing information in the database of the storage device 92, and in Step ST6, the simultaneous print is output from the printer. On the other hand, in the case of the reprinting, in step ST7, the film is scanned (pre-scanned) so as to read a film ID (FID) and a frame number, and then, an image is retrieved using these film ID and frame number so as to specify a reordered image. The image processing condition of simultaneous printing of the specified image is accessed from the database. Then, in the case where there is a change in the image processing condition between the simultaneous printing and the reprinting, the film is again scanned (fine-scanned) so as to obtain an image data. Thereafter, image processing is performed to the obtained image data according to the changed image processing condition, and then, in Step ST8, the image data is output as a reprint.

The above processes will be described in more detail below with reference to FIG. 6A and FIG. 6B.

In the case of the simultaneous printing shown in FIG. 6A, the process from Step ST30 to Step ST33 is same as in the case of the 135-size film of this embodiment, and the process from Step ST34 to Step ST35 is same as in the case of the 240-size film of the first embodiment.

In the case of the reprinting shown in FIG. 68, the process from Step ST40 to Step ST44 is same as in the case of the 240-size film of the first embodiment.

Sequentially, in Step ST45, the accessed image reproducing information is displayed on the display 20, and then, the operator confirms the retrieval result.

In the case where retrieval operation is performed correctly and there is a change in the image processing condition, the film is again scanned (fine-scanned) so as to read the image data for making a reprint. The image data is consecutively subjected to the image processing according to the changed image processing condition and converted by the 3D-LUT or the like according to the output format of print or image data; thereafter, a reprint is output.

Next is a description on the case where there is no change in the image processing condition between the simultaneous printing and the reprinting, or the case where even if there is a change, the change is within a preset allowable range as described above. Both in the case of the 135-size film and the case of the 240 (APS) film, in the reprinting, the reprint is made using the image processed image data stored in the database of the storage device 92, retrieved (specified) by the retrieval device 94a without newly scanning the photographic film. In this case, the reprint is made using the image data without scanning the film again, whereby, it is possible to preferably improve the reproducibility (identity level) between the previous print and the reprint.

Naturally, the process of preparing the simultaneous print is same as that of the case of the above 135-size film or 240-size film. Namely, image processing is performed in the image processing section 66 of the fine-scan processing unit 56, and then, image data (processed image data), which is not yet converted in the signal converter section 68, is stored in the database of the storage device 92. The same processing, conversion and management as in the second embodiment may be performed to the processed image data.

In the reprinting, when the customer brings the film into the laboratory and makes a reorder, the film is pre-scanned so that the operator specifies the image designated for reprinting, and thereafter, image characteristics data is calculated from the image data so as to generate image retrieval data. The retrieval operation is performed using the image retrieval data so as to access the image reproducing information corresponding to the image stored in the database. Thereafter, the retrieval result is displayed on the display 20, and then, the operator watches the retrieval result so as to confirm the retrieval result. If the retrieval result is correct, the image-processed image data corresponding to the image of the image reproducing information is converted by the signal converter section 68 in accordance with the recording medium, and then, output as a reprint.

Moreover, in the case where the particular ID is set to the image-processed image data, when the customer makes a reorder while designating the particular ID in the reprinting, the operator inputs the particular ID to the print system so that the setup image data of the simultaneous print is retrieved by the particular ID. Then, the image data is accessed, and thereafter, output.

In either case, in the case of making the reprint using the image-processed image data, it is possible to very effectively output the reprint by merely converting the image data by the signal converter section 68 in accordance with the recording medium without scanning the film again and carrying out the image processing.

As described above, in this third embodiment, the film is newly scanned so as to make the reprint in accordance with the result as to whether or not there is a change in the image processing condition between the simultaneous printing and the reprinting, and further, the reprint is made using the stored and image-processed image data without scanning the film. As a result, it is possible to effectively output a reprint coincident with the image of the simultaneous print in color and density.

Incidentally, the above embodiments are all related to the image data photographed on the photographic film. Of course, the present invention is not limited to the above cases, and is preferably applicable to a reorder of image data photographed by a digital camera and the like.

The print system of the present invention has been described above. Of course, the present invention is not limited to the above embodiments, and various changes and modifications may be made within the scope of the appended claims without departing from the subject matter of the invention.

As is evident from the above descriptions, according to the present invention, it is possible to effectively output a reprint having the identity with the image of the simultaneous print in color and density.

What is claimed is:

1. A print system, comprising:
an image input device which photoelectrically reads an image photographed on a photographic film so as to input the read image as image data of an input image;
an image processing device which performs image processing on the input image;
an image output device which outputs the processed image as an output image reproducing the image photographed on the photographic film to a predetermined recording medium;
a storage device which stores an image processing condition relative to each image when generating the output image reproducing the photographed image and image retrieval data for retrieving the image processing condition or compressed image data obtained by compressing the image data, as image reproducing information when generating the output image reproducing the photographed image; and
a retrieval device which performs a retrieval operation on the storage device using the image retrieval data in accordance with an image reorder printing request and reads the image processing condition from the storage device,
wherein, when the image reorder printing request is made, an image designated for reorder printing is read photoelectrically from the photographic film, and the image processing is performed on the read image according to the image processing condition when generating the output image reproducing the photographed image retrieved by the retrieval device so that the image is output as an output image.

2. The print system as claimed in claim 1, wherein the image retrieval data is image characteristics data fetched when generating the compressed image data.

3. The print system as claimed in claim 1, wherein a selection can be made as to whether or not the compressed image data is stored in the storage device.

4. The print system as claimed in claim 1, wherein the image retrieval data, the image processing condition and the compressed image data are individually related to each other, and when any one of these data is deleted, the rest of these data is deleted, or when any one of these data is updated, the rest of these data is updated.

5. The print system as claimed in claim 1, wherein the image retrieval data, the image processing condition and the compressed image data are individually related to each other and managed on a database of the storage device every at least one or more of frame number, kind of film, type of camera, customer, particular ID of image, order received year/month/day, order received shop, printer, order, film format, type of film carrier, film mask, year/month/day/time of when photographed, image format and order terminal.

6. The print system as claimed in claim 1, wherein the print system is further connected to the other print systems via a network, and the other print systems connected to the network are also retrieved when performing the retrieval operation using the image retrieval data upon handling the reorder of the image.

7. The print system as claimed in claim 6, wherein the image reproducing information is managed by a server of the network, and the server is also retrieved when performing the retrieval operation.

8. The print system as claimed in claim 1, wherein a retrieval range and a retrieval condition can be preset when performing the retrieval operation.

9. The print system as claimed in claim 1, wherein the image reproducing information, the image retrieval data and the compressed image data are backed up at predetermined timing.

10. The print system as claimed in claim 9, wherein the predetermined timing is any one of system startup, startup inspection, inspection on work finishing, system shutdown, system hang-up, time when instruction is given by an operator and software version up.

11. The print system as claimed in claim 1, wherein the number of frames of storable image reproducing information is set in accordance with print system performance and resource, and further, is changeable.

12. The print system as claimed in claim 2, wherein the image processing condition and the image characteristics data related thereto are independently stored as the image reproducing information, or a set of the image processing condition and the image characteristics data related thereto is stored as the image reproducing information.

13. The print system as claimed in claim 1, wherein the image reproducing information is obtained by loading image reproducing information of a predetermined print system or referring thereto at predetermined timing.

14. The print system as claimed in claim 13, wherein the loaded image reproducing information can be deleted after an image reorder handling is completed.

15. A print system comprising:
an image input device which photoelectrically reads an image photographed on a photographic film so as to input the read image as image data of an input image;
an image processing device which performs image processing on the input image;
an image output device which outputs the processed image as an output image reproducing the image photographed on the photographic film to a predetermined recording medium;
a storage device which stores an image data after being processed by the image processing device and before being converted into an output format corresponding to the predetermined recording medium, as an image reproducing information when generating the output image reproducing the photographed image, together with an image identification code for specifying the image data; and
a retrieval device which performs a retrieval operation on the storage device using the image identification code in accordance with an image reorder printing request and reads the image reproducing information from the storage device,
wherein, when the image reorder printing request is made, the processed image data corresponding to the image designated for reorder printing is read from the storage device using the image identification code, and is output to the predetermined recording medium from the image output device.

16. The print system as claimed in claim 15, wherein the processed image data stored as the image reproducing information is image data subjected to at least one image processing of electronic scaling processing, color gradation, color density correction processing, sharpness processing, and dodging processing.

17. The print system as claimed in claim 15, wherein the processed image data stored as the image reproducing information is related to each other and managed on a database of the storage device every at least one or more of frame number, kind of film, type of camera, customer, particular ID of image, order received year/month/day, order received shop, printer, order, film format, type of film carrier, film mask, year/month/day/time of when photographed, image format and order terminal.

18. The print system as claimed in claim 15, wherein the print system is further connected to the other print systems via a network, and the other print systems connected to the network are also retrieved when retrieving the image reproducing information upon handling the reorder of the image.

19. The print system as claimed in claim 18, wherein the processed image data stored as the image reproducing information is managed by a server of the network, and the server is also retrieved when performing the retrieval operation.

20. The print system as claimed in claim 15, wherein the image reproducing information, the image retrieval data and the processed image data stored as the compressed image data are backed up at predetermined timing.

21. The print system as claimed in claim 20, wherein the predetermined timing is any one of system startup, startup inspection, inspection on work finishing, system shutdown, system hang-up, time when instruction is given by an operator and software version up.

22. The print system as claimed in claim 15, wherein a retrieval range and a retrieval condition can be preset when performing the retrieval operation.

23. The print system as claimed in claim 15, wherein the number of frames of storable image reproducing information is set in accordance with print system performance and resource, and further, is changeable.

24. The print system as claimed in claim 15, wherein the image reproducing information is obtained by loading image reproducing information of a predetermined print system at predetermined timing.

25. The print system as claimed in claim 24, wherein the loaded image reproducing information can be deleted after an image reorder handling is completed.

26. The print system as claimed in claim 1, wherein a selection can be made as to whether the image after the reorder handling is output using the same print system as used when generating the output image reproducing the image photographed on the photographic film, or using another print system.

27. A print system comprising:
an image input device which photoelectrically reads an image photographed on a photographic film so as to input the read image as image data of an input image;
an image processing device which performs image processing on the input image;
an image output device which outputs the processed image as an output image reproducing the image photographed on the photographic film to a predetermined recording medium;
a storage device which stores an image data after being processed by the image processing device and before being converted into an output format corresponding to the predetermined recording medium, an image processing condition relative to each image when generating an output image reproducing the photographed image, an image retrieval data for specifying the image processing condition or the processed image data, or compressed image data obtained by compressing the image data, as an image reproducing information when generating the output image reproducing the photographed image;
a retrieval device which retrieves the processed image data or the image processing condition from the storage device using the image retrieval data in accordance with an image reorder printing request; and
a judgment device which judges whether or not there is a change between the image processing condition when the output image reproducing the photographed image is generated and that when the reorder is made,
wherein, when there is no change in the image processing condition upon the reorder, the image is output using the processed image data stored in the storage device, and
wherein, when there is a change in the image processing condition upon the reorder, the image is newly read from the photographic film, and the image processing condition corresponding to the image stored in the storage device is accessed and changed so that image processing is performed to the read image according to the changed image processing condition.

28. The print system as claimed in claim 27, wherein even though there is a change in the image processing condition upon the reorder, when the change is within a preset allowable range, the image is output using the processed image data stored in the storage device.

29. The print system as claimed in claim 27, wherein the storage device stores the image reproducing information only for a predetermined period, and stores the image retrieval data and the image processing condition or optionally the compressed image data of the image reproducing information after elapse of the predetermined period, and the processed image data is erased.

30. The print system as claimed in claim 29, wherein the predetermined period can be preset by an operator.

31. The print system as claimed in claim 27, further comprising a display capable of displaying an image,
wherein, retrieval result of the image reproducing information is displayed on the display upon the reorder.

32. The print system as claimed in claim 31, wherein when a retrieval object is not found from the retrieval result, or when an error in retrieving is made, images listed as a second candidate and the following can be displayed, or instruction for retrieving can be given again.

33. The print system as claimed in claim 27, further comprising a back-printing device which performs back-printing on a print of the output image,
wherein the back-printing showing retrieval result of the image reproducing information is performed upon the reorder.

34. The print system as claimed in claim 27, wherein when the storage device stores the image reproducing information, the number of frames of storable image reproducing information is set in accordance with print system performance and resource, and further, is changeable, or further optionally a selection can be made as to whether or not the compressed image data is stored.

35. The print system as claimed in claim 27, wherein the image processing condition and the image characteristics data related thereto are independently stored as the image reproducing information, or a set of the image processing condition and the image characteristics data related thereto is stored as the image reproducing information.
